(19) United States
(12) Patent Application Publication
(10) Pub. No.: US 2013/0057668 A1
(43) Pub. Date: Mar. 7, 2013

(54) DEVICE AND METHOD FOR DETECTING DRIVER'S CONDITION USING INFRARED RAY SENSOR

(71) Applicant: Sam Yong Kim, Hwaseong (KR)

(72) Inventor: Sam Yong Kim, Hwaseong (KR)

(73) Assignee: HYUNDAI MOTOR COMPANY, Seoul (KR)

(21) Appl. No.: 13/313,686

(22) Filed: Dec. 7, 2011

(30) Foreign Application Priority Data
Sep. 2, 2011 (KR) 10-2011-0089104

(51) Int. Cl. H04N 7/18

(52) U.S. Cl. 348/77; 348/E07.085

(57) ABSTRACT

A device for detecting driver's condition is provided. More specifically, an infrared ray (IR) sensor which includes a light-emitting unit that emits a light signal, and a light-receiving unit that receives the light signal, measures a distance to an obstacle in front of the IR sensor using a phase difference between a light signal emitted from the light-emitting unit and a light signal received by the light-receiving unit. Additionally, a camera photographs a driver's face and detects the driver's face from the photographed image. An electronic controller then determines whether a recognition error has occurred using data measured by the IR sensor and the camera, and analyzes a generated recognition error when a recognition error occurs.

### CROSS-REFERENCES TO RELATED APPLICATIONS

Priority to Korean patent application number 10-2011-0089104, filed on Sep. 2, 2011, which is incorporated by reference in its entirety, is claimed.

### BACKGROUND OF THE INVENTION

1. Field of the Invention

The present invention relates to a device and method for detecting driver's condition using an infrared ray (IR) sensor, and more particularly, to a device and method for detecting driver's condition using an infrared LED and camera.

2. Description of the Related Art

Driver condition detecting devices are able to monitor a driver's mental state and alertness by image analyzation of the driver's face, expression and position. These devices usually include a lighting device along with a camera for smooth photographing even in at night or in a dark environment, such as a tunnel.

However, if the driver's condition is checked by only images photographed by a camera, it is difficult to appropriately respond to errors such as a deterioration phenomenon by a photonic environment, an image error from dust on the camera lens, impossibility of checking part of driver's face, and a failure to recognize driver's condition according to driver's position change, etc. These errors are unconditionally treated as recognition errors, which are left unattended.

Further, when an error is unconditionally treated as a recognition error, user is not alerted of what problem actually caused the recognition error, and thus cannot appropriately respond to such a recognition error. Therefore, in the conventional devices, the user is neither alerted of the recognition error nor shown how to correct the recognition error.

### SUMMARY OF THE INVENTION

The present invention has been made in view of the above problems, and provides a device for detecting driver's current condition (e.g., their alertness, soberness, etc.), which reduces recognition errors that are generated by a camera malfunction or the driver's position by checking driver's condition using an infrared LED and a camera.

In accordance with an aspect of the present invention, a device for detecting driver's condition includes: an infrared ray (IR) sensor that embodies a light-emitting unit, which emits a light signal (e.g., an infrared light signal), and a light-receiving unit, which receives the light signal, and measures a distance to an obstacle in front using a phase difference between a light signal emitted from the light-emitting unit and a light signal received by the light-receiving unit; a face recognition camera that photographs a driver's face and detects the driver's face from the photographed image; and an electronic controller that determines that a recognition error has occurred using data measured through the IR sensor and the face recognition camera, and analyzes a generated recognition error if a recognition error has occurred.

In accordance with another aspect of the present invention, a method for detecting driver's condition includes: measuring a distance to an obstacle in front through an IR sensor using a phase difference between a light signal emitted from a light-emitting unit and a light signal received by a light-receiving unit (step 1); photographing a driver's face and detecting the driver's face from the photographed image (step 2); determining whether a recognition error has occurred using data measured at step 1 and step 2 through an electronic controller, and analyzing the generated recognition error if the recognition error has occurred (step 3).

According to the present invention, recognition errors, which are generated according to the surrounding environment or the driver's position in a driver condition detecting device, are reduced. Further, because an infrared ray sensor as well as a camera is used, recognition errors can be classified according to the number of cases, and thus the cause of each recognition error can be more easily recognized. Finally, by providing an error message to user, user can be induced to correct the recognition error.

### BRIEF DESCRIPTION OF THE DRAWINGS

The objects, features and advantages of the present invention will be more apparent from the following detailed description in conjunction with the accompanying drawings, in which:

FIG. 1 illustrates a configuration of a driver's condition detecting device according to an exemplary embodiment of the present invention;

FIG. 2 illustrates a driver's condition detecting device prepared in a car according to an exemplary embodiment of the present invention;

FIG. 3 is a flowchart illustrating a method for detecting driver's condition according to an exemplary embodiment of the present invention; and

FIG. 4 illustrates a method of checking a distance with driver according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of all motor vehicles in general such as passenger automobiles including sports utility vehicles (SUV), buses, trucks, various commercial vehicles, watercraft including a variety of boats and ships, aircraft, and the like, and includes gas combustion vehicles, diesel vehicles, hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

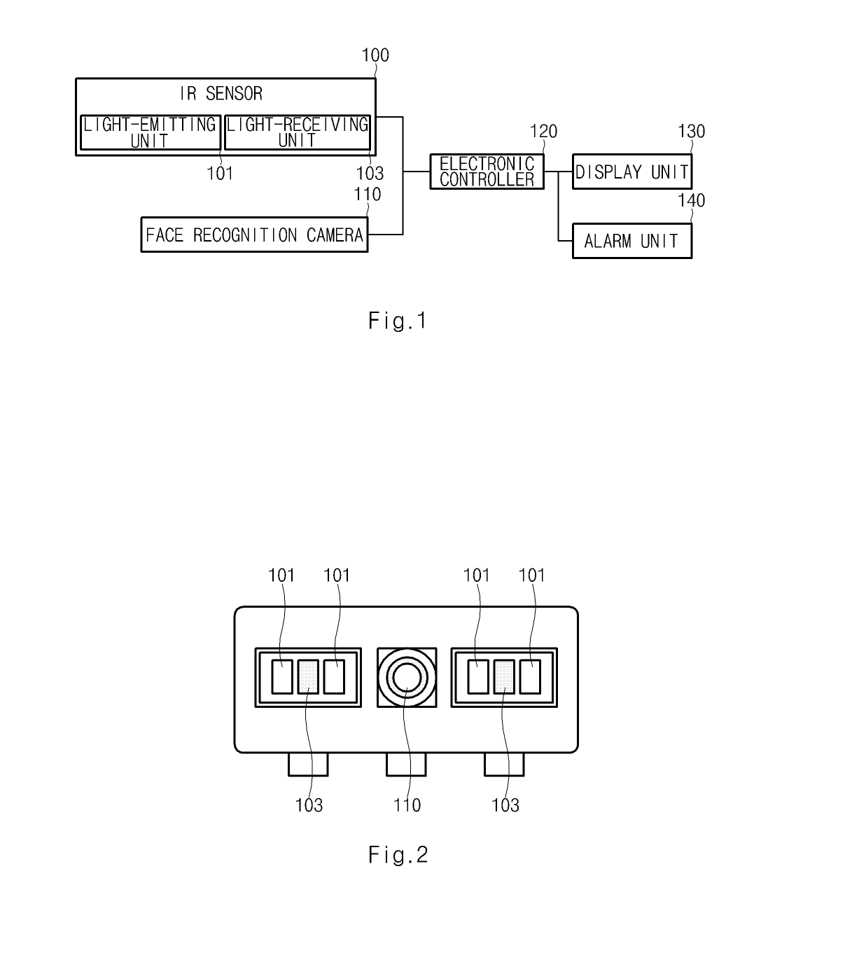

FIG. 1 illustrates a configuration of a driver's condition detecting device according to an exemplary embodiment of the present invention.

As illustrated in FIG. 1, a driver's condition detecting device according to the present invention includes infrared ray (IR) sensor 100, a face recognition camera 110, an electronic controller 120, a display unit 130, and an alarm unit 140. The IR sensor 100 is a device that is configured to measure the distance between an obstacle in front of the IR sensor and the IR sensor 100 itself, and includes a light-emitting unit 101 that emits preset light signals and a light-receiving unit 103 that receives surrounding light signals.

The light-emitting unit 101 provides illumination for the face recognition camera 110, and emits light that is receives by the light-receiving unit 103. A visible ray or far-infrared light emitting diode (LED) can be used as the light-emitting unit 101, but an infrared ray LED (IR LED) is preferable.

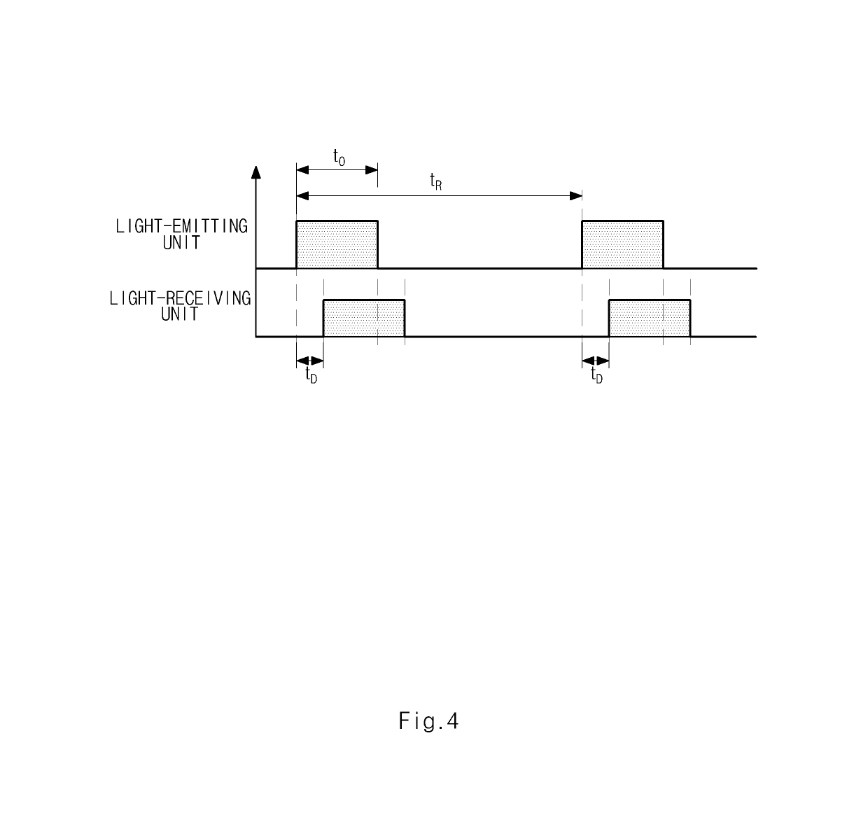

The distance between the IR sensor 100 and an object in front of the IR sensor is, for example, measured according to the phase difference between a light signal emitted from the light-emitting unit 101 and a light signal received by the light-receiving unit 103. Here, an object in front of the IR sensor refers to an object that exists in front of the light-emitting unit 101 and the light-receiving unit 103, e.g., a driver's face, a driver's upper body and/or the driver's seat, etc. The method of measuring the distance between the IR sensor 100 and an obstacle in front is explained in detail later with reference to FIG. 4.

The face recognition camera 110 is configured to photograph a driver's face. The driver's face is then detected in the image photographed by the face recognition camera 110. The face recognition camera 110 is often disposed adjacent to the IR sensor, and thus an object placed in front of the face recognition camera 110 is recognized as an object in front of the IR sensor 100.

The electronic controller 120 determines whether a recognition error has occurred based on data measured by the IR sensor 100 and the face recognition sensor 110. The electronic controller 120 then checks the current condition of driver if a recognition error has not occurred, and analyzes a generated recognition error if a recognition error has occurred. Therefore, the electronic controller 120 can monitor the driver's current condition, and determine whether the driver's condition is in a normal driving condition or in an impaired driving condition when a recognition error has not occurred.

In the event a recognition error has occurred, the electronic controller 120 provides the user with an appropriate information message through the display unit 130 according to the analyzed recognition error so that driver can take an appropriate measure to correct the recognition error. The electronic controller 120 analyzes recognition errors according to each number of cases using data measured by the IR sensor 100 and the face recognition camera 110. Therefore, the electronic controller 120 can determine what an obstacle in front IR sensor is and whether driver's position is normal according to the distance measured by the IR sensor 100. For example, when the measured distance is between 0 cm and 30 cm, it can be determined that an object or driver's face is very close to the face recognition camera 110. When the measured distance is between 40 cm and 60 cm, it can be determined that the driver's position is normal and the measured distance is a distance to the driver's upper body. Alternatively, when the measured distance is between 80 cm and 90 cm, it can be determined that the driver's position is abnormal and the measured distance is the distance to the driver's seat not to the driver.

The display unit 130 displays a driver's condition message indicating the driver's condition according to a signal transmitted from the electronic controller 120, a recognition error message indicating a generated recognition error, a recognition error analysis message indicating the analysis of a generated recognition error, and/or an information message configured to provide correction instructions for a recognition error based on the results of the recognition error analysis. The driver's condition message is displayed differently depending upon whether the driver's condition is normal or impaired.

As a result of the electronic controller 120, if the driver's condition is impaired, the alarm unit 140 can output a warning alarm. The alarm unit 140 may in some embodiments be a voice output device, and may be configured to output a recognition error message or a recognition error analysis message in an audio format when a recognition error occurs.

For example, in the case of a general photonic environment and driver's position, the distance to the driver's upper body measured by the IR sensor 100 is estimated to be between 40 cm and 60 cm, and when a driver's face is detected in an image photographed by the face recognition camera 110, the electronic controller 120 determines that a recognition error has not occurred, and checks the driver's current condition. The result of checking the driver's current condition can be divided into a normal driving condition or an impaired driving condition, and a message or a warning alarm is outputted through the display unit 130 or the alarm unit 140.

As another example, when a driver's face approaches the camera, if the distance to the driver's face measured by the IR sensor 100 is estimated to be between 0 cm and 20 cm, and driver's face is not normally detected in an image photographed by the face recognition camera 110, the electronic controller 120 determines that a recognition error has occurred, analyzes the state as a facial recognition impossible state, and can output a recognition error message and an information message to check driver's position for monitoring driver's condition through the display unit 130 or the alarm unit 140.

As another example, when an object exists in front of the face recognition camera 110, the distance to the object measured by the IR sensor 100 is estimated as a fixed value of 15 cm, and when a driver's face is not detected in an image photographed by the face recognition camera 110, the electronic controller 120 determines that a recognition error has occurred, analyzes the state as a facial recognition impossibility, and outputs a recognition error message and an information message to check an object in front of the face recognition camera 110 through the display unit 130 or the alarm unit 140.

As another example, when the driver's face is in a very dark or very bright environment due to backlight conditions or lateral light, if the distance to the driver's upper body, which is measured by the IR sensor 100, is estimated to be between 40 cm and 60 cm, and driver's face is not detected in an image photographed by the face recognition camera 110, the electronic controller 120 determines that a recognition error has occurred, analyzes the state as a facial recognition impossibility, and outputs a recognition error message and an information message to adjust photonic environment through the display unit 130 and the alarm unit 140.

As another example, when a driver's face is not detected in a driver's seating position, if the distance to the driver's seat, which is measured by the IR sensor 100, is estimated to be between 80 cm and 90 cm, and driver's face is not detected in an image photographed by the face recognition camera 110, the electronic controller 120 determines that a recognition error has occurred, analyzes the state as a fault detection state, and outputs an error recognition message, which informs the driver that a condition cannot be determined, through the display unit 130 or the alarm unit 140.

As another example, when a driver's face is not detected in general photonic environment, if the distance to the driver's upper body, which is measured by the IR sensor 100, is estimated to be between 40 cm and 60 cm, and the driver's face is not detected in an image photographed by the face recognition camera 110, the electronic controller 120 determines that a recognition error has occurred, analyzes the state as a fault detection state, and outputs an error recognition message, which informs the driver that the state cannot be determined, through the display unit 130 or the alarm unit 140.

The criteria for the distance measured by the IR sensor 100 are not limited to the centimeter range explained in the above exemplary embodiment, and the actual distance to the driver's face and the actual distance to the driver's upper body can be changed according to driver's body type through alternative configurations of the IR sensor data. Hence, the criteria for the distance measured by the IR sensor 100 can be differentially applied.

FIG. 2 illustrates a driver's condition detecting device prepared in a car according to an exemplary embodiment of the present invention. As illustrated in FIG. 2, the IR sensor 100 and the face recognition camera 110 of a driver's condition detecting device according to an exemplary embodiment of the present invention can be disposed on the same plane. Illustratively, a light-emitting unit/receiver configuration, where one light-receiving unit 103 is disposed between two light-emitting units 101, is disposed on both sides of the face recognition camera 110. In this embodiment, the distance to an obstacle in front can be measured by the IR sensor 100, and the driver's face may be photographed by the face recognition camera 110 accordingly.

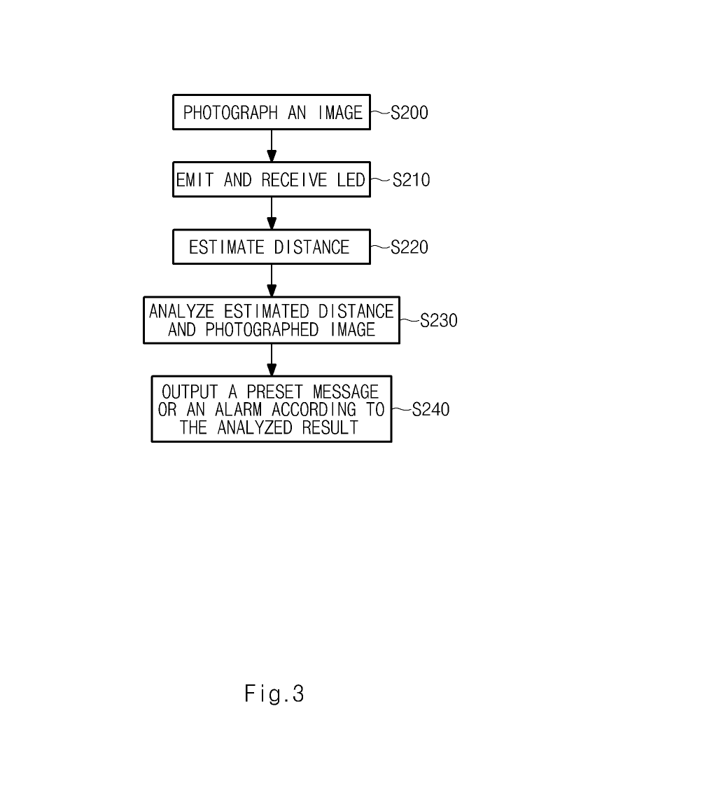

FIG. 3 is a flowchart illustrating a method for detecting driver's condition according to an exemplary embodiment of the present invention. As illustrated in FIG. 3, the image of driver's face is photographed (200). Next, the light-emitting unit 101 emits light signals, and the light-receiving unit 103 receives the light signals (210). The steps 200 and 210 can occur at the same time, in reverse order, or sequentially. Then, the distance to the obstacle in front of the IR sensor 100 is estimated using a phase difference between the light signal emitted from the light-emitting unit 101 and the light signal received by the light-receiving unit 103 (220). Thereafter, the distance to the obstacle estimated at step 220 and the driver's face image photographed at step 200 are analyzed by the electronic controller 120 (230), and based on these analyzed results, at step 230, a preset message or alarm is outputted through the display unit 130 and the alarm 140 (240). The preset message can be a driver's condition message, a recognition error message, a recognition error analysis message, and/or an information message.

FIG. 4 illustrates a method of checking a distance with driver according to an exemplary embodiment of the present invention. As illustrated in FIG. 4, if the light-emitting unit 101 emits light signals for t_{O} at every t_{R}, the light-receiving unit 103 receives light signals after delay time for t_{D}. Where t_{O} is the time at which the light signal was sent by the light emitting unit 101, t_{R} is the time at which that same light signal was received by the light receiving unit 103, and t_{D} is the time delay between the two. At this time, the distance from the IR sensor 100, which includes the light-emitting unit 101 and the light-receiving unit 103, to the obstacle can be calculated using the Formula 1 below, and the Formula 1 may have a centimeter unit precision degree at about 1 m distance to the obstacle.

$$D = \frac{c \times {t}_{D}}{2} \qquad Formula 1$$

Here, “D” is the distance to an obstacle and “c” is the speed of light.

As described above, according to the present invention, the distance from the IR sensor 100 to the obstacle in front of the IR sensor can be estimated with a high degree of precision, and thus the distance to the obstacle, which can be changed by the camera environment or driver's position, etc., and the driver's face can be recognized by the face recognition camera 110 at the same time. Therefore, the present invention provides a method for monitoring and analyzing recognition errors by using data, analyzing a recognition error, finding the cause of the recognition error, and correcting the recognition error.

The present invention can be implemented as a computer readable code readable in a processor or controller readable recording medium. The computer readable recording medium includes all kinds of recording devices where processor readable data may be stored. Some examples of the processor readable medium are RAM, RAM, CD-ROM, magnetic tape, floppy disk, smart cards, and optical data storage device, etc. Further, the processor readable recording medium can be distributed to a computer system connected by a network, and processor/controller readable codes can be stored and executed in a distributed manner, over e.g., a telematics or Controller Area Network (CAN).

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A device for detecting driver's condition, the device comprising:
a infrared ray (IR) sensor that includes a light-emitting unit, which is configured to emit a light signal, and a light-receiving unit, which is configured to receive the light signal, and measures a distance to an obstacle in front of the IR sensor using a phase difference between the light signal emitted from the light-emitting unit and the light signal received by the light-receiving unit;
a camera configured to photograph a driver's face and detect the driver's face from the photographed image; and
an electronic controller configured to determine that a recognition error has occurred using data measured via both the IR sensor and the camera, and analyze any generated recognition error when a recognition error occurs.

2. The device of claim 1, further comprising:
a display unit configured to display at least one of a group consisting of a recognition error message, a recognition error analysis message, and an information message when the recognition error occurs.

3. The device of claim 1, wherein the obstacle in front of the IR sensor is at least one of the driver's face, driver's upper body and driver's seat.

4. The device of claim 1, wherein the electronic controller is configured to identify the obstacle in front of the IR sensor or driver's position based on the distance measured by the IR sensor.

5. The device of claim 1, wherein the IR sensor is configured to measure the distance to the obstacle in front of the IR sensor using a delay time which occurs between the light signal being sent and the light-receiving unit receiving the light signal.

6. The device of claim 1, wherein the electronic controller is configured to determine whether the driver's condition is in a normal driving condition or in an impaired driving condition using data measured by the IR sensor and the camera when a recognition error has not occurred.

7. The device of claim 6, further comprising:
an alarm unit that is configured to output a warning alarm when the driver's condition is in an impaired driving condition as a result of the determination by the electronic controller.

8. A method for detecting driver's condition, the method comprising:
Measuring, by an Infrared (IR) sensor) a distance to an obstacle in front the IR sensor using a phase difference between a light signal emitted from a light-emitting unit and a light signal received by a light-receiving unit (step 1);
photographing, by a camera, a driver's face and detecting, by the camera, the driver's face from the photographed image (step 2);
determining, by a controller, whether a recognition error has occurred using data measured at step 1 and step 2, and analyzing, by the controller the generated recognition error if the recognition error has occurred (step 3).

9. The method of claim 8, further comprising:
displaying, by a display unit, at least one of a recognition error message, a recognition error analysis message and an information message when a recognition error occurs (step 4).

10. The method of claim 8, wherein the obstacle in front of the IR sensor is one of a driver's face, driver's upper body and driver's seat.

11. The method of claim 8, further comprising identifying, by the controller, the obstacle in front of the IR sensor or driver's position based on the distance measured at step 1.

12. The method of claim 8, wherein the step 1 measures the distance to the obstacle in front of the IR display using the time delay between the light-receiving unit receiving the light signal and the light-emitting unit emitting the light signal.
